(19) United States
(12) Patent Application Publication
(10) Pub. No.: US 2013/0332220 A1
(43) Pub. Date: Dec. 12, 2013

(54) Service planning tool for wind turbines

(71) Applicant: Kaj Skov Nielsen, Issaquah, WA (US)

(72) Inventor: Kaj Skov Nielsen, Issaquah, WA (US)

(21) Appl. No.: 13/493,017

(22) Filed: Jun. 11, 2012

(51) Int. Cl. G06Q 10/10

(52) U.S. Cl. 705/7.21

(57) ABSTRACT

A method of scheduling a service of a wind turbine is provided. A projected energy production and/or a projected revenue production of a wind turbine over a specific time period is calculated, and a service for the wind turbine during the specific time period based upon the projected energy production and/or the projected revenue production is scheduled. Further, a non-volatile computer readable medium storing a program code executing the method and a service planning tool for wind turbines are provided.

### FIELD OF INVENTION

A service planning tool for wind turbines and a method of scheduling a service of a wind turbine are provided.

### BACKGROUND OF INVENTION

Renewable energy is energy which comes from natural resources such as sunlight, wind, rain, and tides etc. which are renewable, i.e. naturally replenished. For example, wind power and tidal power are used to produce energy, for example electricity. Tidal power is a form of hydropower that converts energy of tides into energy.

A focus in the wind turbine industry and the tidal power industry is to reduce costs of energy for operating wind turbines and the tidal power equipment. Another focus is to optimize yield and profit. It is known for example to shut down or reduce operation of a wind turbine at very high wind speeds to lengthen lifetime, because harm and/or damage of the structure of the wind turbine may be avoided or reduced.

It is also known to use weather forecasts to find time windows in which service of offshore wind turbines is possible or a blade of a wind turbine may be inspected, for example wave height low enough or wind speed low enough.

### SUMMARY OF INVENTION

The energy loss during service, maintenance and retrofits on wind power plants build with very large turbines will represent a significant value. In order to simplify the service planning, a service planning tool is provided which automatically assists in the process of which turbines to stop based upon projected energy production and/or projected revenue production. Further, a method of scheduling and/or planning a service of a wind turbine is provided.

The service planning tool and the method of scheduling and/or planning a service is described with regard to wind turbines and the wind turbine industry. However, the service planning tool and the method may also be applied for tidal power equipment and the tidal power industry as the tools and methods are very similar and the energy of tidal power will be much more predictable.

The improved energy based service planning tool is a tool assisting in deciding which wind turbine to repair at what time based on a projection of the expected power production and/or expected revenue generation during a selectable time period.

The method of scheduling a service of a wind turbine comprises calculating a projected energy production and/or a projected revenue production of a wind turbine over a specific time period, and scheduling a service for the wind turbine during the specific time period based upon the projected energy production and/or the projected revenue production. The service for the wind turbine is scheduled so that an energy production loss and/or a revenue production loss of the wind turbine is/are minimized.

The service planning tool is for example a computer program which executes the method of scheduling the service of a wind turbine when run on a computer. The computer may be any kind of processing device including a processor, memory and display unit, for example a screen or monitor. Computers include personal computers, smart phones, tablets, programmable logic controllers, etc.

When a service for the wind turbine has been scheduled, a service starting time and the projected energy loss and/or revenue loss associated with the scheduled service is displayed on the display unit, for example on a monitor of a computer.

The first step is to identify the wind turbines which need to be serviced. Wind turbines may be serviced because of technical problems, or because of a regular maintenance schedule. This first step may also be called ‘task list’. The task list includes for a specific time period, for example for five days starting on a specific date, which turbines have to be serviced and how much time for the service is required. For example, the task list may show that for the time period of June 4 through Jun. 8, 2012, wind turbine no. 2 needs four hours of maintenance service.

Tasks that need to be scheduled will need to be available in a prioritized manner with associated time estimates for each task. Tasks can be manually entered by the site operator or as a remote office function or they could be imported from other computerized task planning tools.

The priorities for tasks of the task list are based on a variety of variables that may include: 1) unscheduled stops, 2) scheduled maintenance, 3) retrofits, 4) parts and consumables available on site, 5) safe weather conditions and low wind duration compared to job time requirement, 6) available equipment and 7) crews and training level. For example, an unscheduled stop of a wind turbine, for example because a part of the turbine is broken, has the highest priority so that the wind turbine will be repaired as soon as possible and ready for normal operation. The priorities may change according to circumstances when preparing the task list.

In order to make such a decision of scheduling a service time so that the energy production loss of the wind turbine is minimized, a plurality of elements and/or criteria may be considered. Such elements/criteria may be for example weather conditions/weather forecasting, wake model or fluid dynamic model of the wind turbine, wind to power conversion, power price forecasting, availability of service equipment/service teams, etc.

Weather Conditions/Weather Forecasting

A wind turbine may only be serviced under certain weather conditions. In particular, when a service person needs to go up to the hub or nacelle of the wind turbine, the wind speed and precipitation may not exceed a certain threshold.

For example, the energy production loss of wind turbines may be considered by planning service during low winds of the year or by not servicing selected wind turbines on windy days or other variations.

Advancements in the ability to generate accurate forecasts made it possible to generate more accurate local forecasts for specific wind power plant locations. Depending on a forecast vendor, the forecast may contain a large number of ensembles and each ensemble may contain a large number of individual variables. The list of variables may include: wind speed, wind direction, pressure, temperature, sheer, turbulence, precipitation, cloud cover, etc. The forecast may even include measurements for multiple altitudes, or sub sets for different altitudes.

Wake Model or Fluid Dynamic Model

Wind turbines do not only produce power, they cause wakes—similar to what forms in bodies of water—that are invisible ripples and waves and other disturbances in the atmosphere downstream that may damage turbines and decrease efficiency of downstream turbines.

Based on the weather forecast and the local terrain and turbine geometry, a wake model or a fluid dynamic model may be applied in order to get a more true representation of the projected weather conditions at the location of each individual turbine in a larger wind power plant. This will take turbine wake into account, for example wind turbines where a portion of the rotor surface will be shadowed by upwind turbines and thus not see as high average wind speed. It will also account for elevation differences between turbines and the associated pressure differences and temperature differences. Depending on the type of model, it may account for speed up effects caused by the contours in the terrain.

Wind-To-Power-Conversion

The weather forecast for each wind turbine (for example including wind speed, wind direction and temperature on a specific day), which may include consideration of a wake model, may now be converted to power by a wind-to-power-algorithm. The wind-to-power-algorithm may be based on a power curve provided by manufacturers of wind turbines, or based on an actual power curve for a given wind direction under similar conditions or a neural network trained to predict power output based on a larger number of input variables, or any future combination of wind to power conversion algorithm. Such a wind-to-power-algorithm includes for example program code (computer software) executed by a computing device.

In an embodiment, a projection of power for each individual turbine, or at least for all the turbines, to be serviced, is available as time series indicating what level of production will be available at any given time per turbine for the forecast duration.

Power Price Forecasting/Revenue Forecast

In order to convert the energy forecast (power production) to a revenue forecast, it is necessary to know the energy price for the duration of the weather forecast period. This may or may not be possible under all circumstances and the supplier of this energy price forecast may base the forecast on an arsenal of different functions including historic data, weather data, seasonal data, climate data, consumer behavior, equipment availability, transmission availability, etc.

For a power price prediction method, supplier and accuracy may vary from region to region and it may not even be available at all. In some regions, renewable energy is sold to a fixed price and in such regions the conversion from projected production to projected revenue will be simple multiplication of a fixed price and the projected production level for the given time periods. Prices may change seasonally, daily, hourly or by the minute depending on the local market rules.

In an embodiment, the power price may be expected to go negative, which may radically change the projected optimal time to start the service of the wind turbine.

Availability of Service Equipment/Service Teams

Another criteria of scheduling a service time so that the energy production loss of the wind turbine is minimized, is availability of service equipment/service teams, etc. For example, if service equipment needs to be rented, the equipment may be cheaper to rent during certain times of the year. Also, if special tools are needed for the service, the availability of such tools needs to be considered.

When service teams, conducting the service of the wind turbine, need to be hired, the price for hiring such teams may vary throughout the year.

In an embodiment, service tasks may be scheduled for several service teams, so that the service will be done in a shorter time period. A shorter service means less energy production loss of the wind turbine. In another embodiment, service tasks may be scheduled for service crews with different skill sets.

In another embodiment, travel time of service crews between visits of the wind turbine may be considered. In another embodiment, travel time is priced and travel time and lost revenue are combined in service schedule recommendation.

Usually, the service teams/crews work during certain hours of the week, for example, Monday through Friday from 8:00 am until 5:00 pm. Such work week constraints need to be considered, so that for example a service may not be planned for a Saturday. In another embodiment, work week constraint may also include holidays and/or vacation time of service crews.

Based on a comparison between the projected energy for the turbines scheduled for a visit, the service planning tool finds time periods of the appropriate durations that result in the lowest possible production loss. The tool proposes a service starting time and lists a projected energy loss associated with the projected stoppage time.

If the revenue option is selected, the projected production is converted to projected revenue for each of the turbines prioritized from the task list. The service tool now finds an appropriate time window, where the revenue loss is the lowest and lists the projected lost energy as well as the projected lost revenue.

### BRIEF DESCRIPTION OF THE DRAWINGS

FIG. 1 shows an embodiment of a service planning tool for scheduling a service of a wind turbine based on a projected energy production.

FIG. 2 shows an embodiment of a service planning tool for scheduling a service of a wind turbine based on a projected revenue production.

### DETAILED DESCRIPTION OF INVENTION

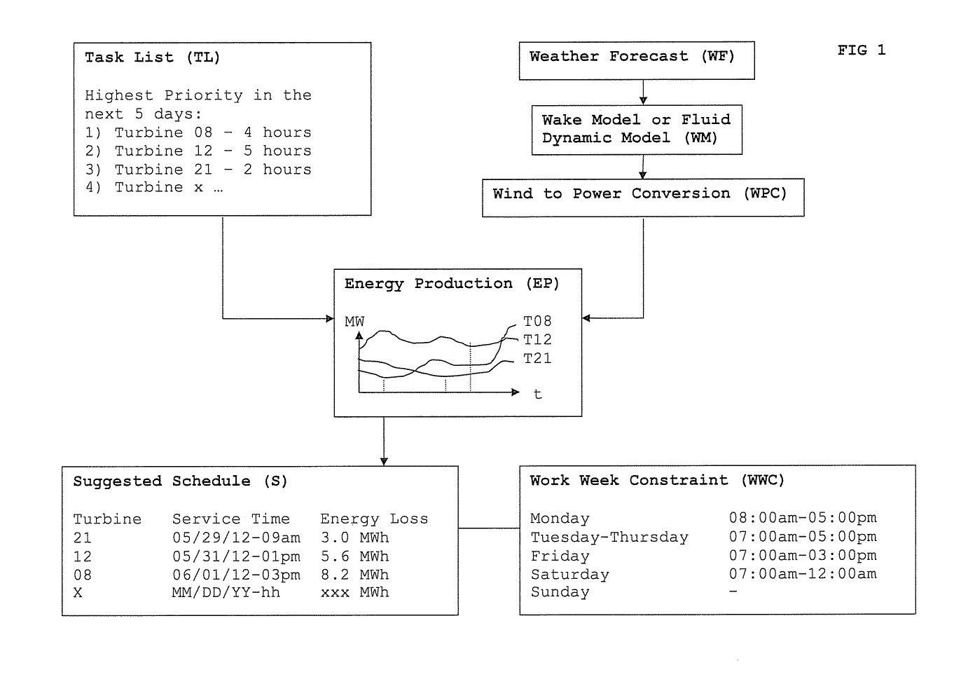

FIG. 1 shows an embodiment of a service planning tool for scheduling a service of a wind turbine based upon a projected energy production.

The task list TL shows which wind turbines need to be serviced in the next five days, wherein the wind turbines are listed according to the highest priority. For example, wind turbine no. 08 needs to be serviced first, i.e. has the highest priority. The duration of service for wind turbine no. 08 is estimated for 4 hours. Next, wind turbine no. 12 needs to be serviced with a service time of 5 hours scheduled. As third priority, wind turbine no. 21 is listed having an estimated service time of 2 hours, etc.

Depending on how many service teams and/or service equipment is available, wind turbines 08, 12, 21 may be serviced at the same time or consecutively. The task list TL lists the service priorities for the next 5 days. However, each task list may include a different time horizon, for example 2 days, 3 weeks, 5 months or even one year.

According to the embodiment shown in FIG. 1, the factors which influence a service planning for the wind turbines 08, 12, 21 are the weather forecast WF, the wake model WM (or fluid dynamic model), and the wind-to-power-conversion WPC. Additional factors may be included, for example availability of service equipment. Regarding the weather forecast WF, one embodiment may be to use a simple persistency forecast for the entire forecast period (five days in this example).

Based upon the task list TL and the factors WF, WM and WPC, a projected energy production EP for each wind turbine 08, 12, 21 for the estimated service time over the specific time period according to the task list TL, which is five days, is calculated. For example, for the wind turbine 08, the projected energy production for the estimated 4 hours of service is calculated. Also, for wind turbine 12 and for wind turbine 21, the projected energy production for 5 hours (wind turbine 12) or 2 hours (for wind turbine 21) is calculated over the time period for the next five days. The projected energy production EP may be shown in a diagram as shown in FIG. 1, or may be shown in a table or any other adequate way to show a projected energy production.

Based on the projected energy production EP, the service tool schedules a service appointment for each wind turbine within the next five days. The service tool selects a time frame where the projected energy production for each wind turbine is the lowest so that energy losses are minimized (see dashed lines in diagram of energy production EP).

A suggested schedule S is provided and displayed by the service tool. As can be seen, for wind turbine 21, the tool suggested a service appointment on May 29, 2012, starting at 09:00 am. Together with the service appointment, the projected energy loss is displayed. For wind turbine 21, the energy loss is 3.0 MWh (1.5 MW for 2 h). For wind turbine 12, a service time of May 31, 2012, starting at 01:00 pm is suggested resulting in an energy loss of 5.6 MWh (1.12MW for 5h). For wind turbine 08, a service time of Jun. 1, 2012, starting at 03:00 pm is suggested, the energy loss being estimated at 8.2 MWh (2.05 MW for 4 h). The different projected energy production per MWh results for example from different types of wind turbines and/or different weather conditions.

Connected to the suggested schedule S is a work week constraint WWC which shows the availability of the service crew(s). According to the embodiment in FIG. 1, the suggested service appointments are in accordance with the work week constraint. The feature WWC is optional, since service crews may not have such a constraint.

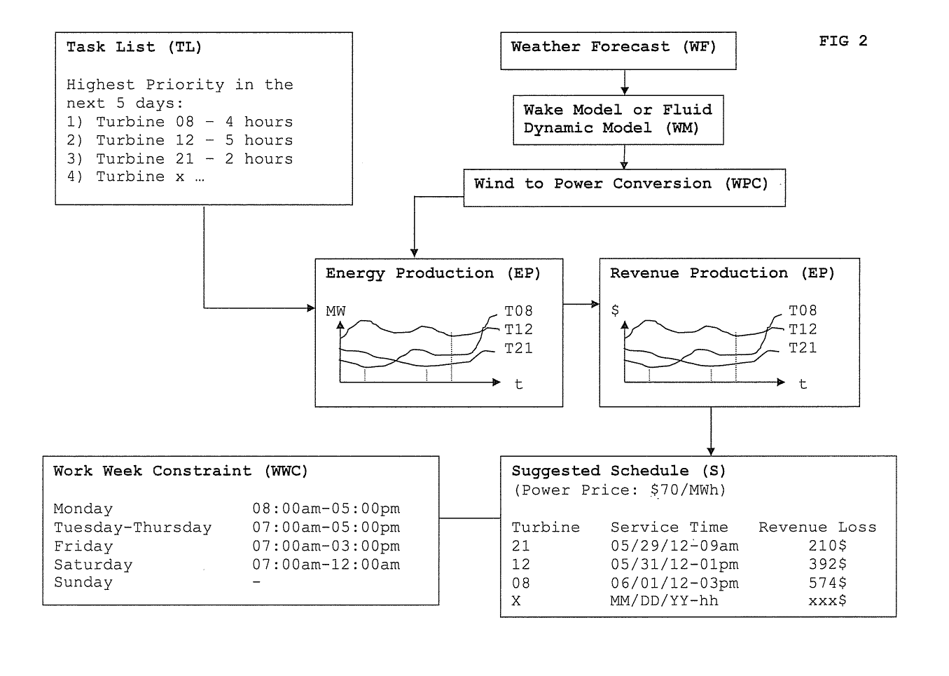

FIG. 2 shows an embodiment of a service planning tool for scheduling a service of a wind turbine based on a projected revenue production.

FIG. 2 is based upon FIG. 1, wherein an additional feature, the projected revenue production RP is shown. Next to the projected energy production EP, the projected revenue production RP is calculated, wherein the projected energy is multiplied with the energy price for each trading period for the next 5 days.

The suggested schedule S would then show the projected revenue loss (instead the energy loss as in FIG. 1) next to each wind turbine. For example, if the power price for the next five days is 70$/MWh, the revenue loss for wind turbine 21 would be 3.0 MWh*70$/MWh=210$. The revenue loss for wind turbine 12 would be 392$, and for wind turbine 08 it would be 574$.

FIGS. 1 and 2 show two embodiments of the service planning tool. However, the service planning tool may include more or less options or features as needed by the operator.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. Method of scheduling a service of a wind turbine, comprising:
calculating a projected energy production and/or a projected revenue production of a wind turbine over a specific time period, and
scheduling a service for the wind turbine during the specific time period based upon the projected energy production and/or the projected revenue production.

2. The method as claimed in claim 1, wherein the service for the wind turbine is scheduled such that an energy production loss or a revenue production loss of the wind turbine is minimized.

3. The method as claimed in claim 1, further comprising:
displaying a service starting time and a projected energy loss and/or a projected revenue loss associated with the scheduled service on a display unit.

4. The method as claimed in claim 1, wherein a calculation of the projected energy production or the projected revenue production of the wind turbines comprises:
identifying a wind turbine which needs to be serviced during the specific time period,
providing a weather forecast for the specific time period,
conducting a wind-to-power conversion based on the weather forecast,
determining the projected energy production of the wind turbine based upon the wind-to-power conversion.

5. The method as claimed in claim 4, wherein the calculation of the projected energy production or projected revenue production further comprises:
providing a wake model or a fluid dynamic model based upon the weather forecast.

6. The method as claimed in claim 4, wherein a calculation of the projected revenue production further comprises:
providing an energy price for generated power by the wind turbine during the specific time period, and
calculating the projected revenue production based upon the specific time period and the energy price for the specific time period.

7. The method as claimed in claim 1, wherein a computer including a processor, memory and display unit comprises a program code for calculating the projected energy production and/or projected revenue production, and for scheduling the service for the wind turbine.

8. A non-volatile computer readable medium storing a program code executing a method of scheduling a service of a wind turbine according to claim 1.

9. Service planning tool for wind turbines, comprising:
a calculation unit configured to
calculate a projected energy production and/or a projected revenue production of a wind turbine over a specific time period, and
schedule a service for the wind turbine during the specific time period based upon the projected energy production and/or the projected revenue production.

10. The service planning tool as claimed in claim 9, wherein the calculation unit includes program code which is stored on a non-volatile computer readable medium.

11. The service planning tool as claimed in claim 9, wherein the service for the wind turbine is scheduled so that an energy production loss and/or a revenue production loss of the wind turbine is minimized.

12. The service planning tool as claimed in claim 9, wherein a service starting time and a projected energy loss associated with the scheduled service is displayed on a display unit of a computer.

13. The service planning tool as claimed in claim 9, wherein service tasks for wind turbines are entered into the service planning tool by a user or are automatically imported into the service planning tool from another computing device.

14. The service planning tool as claimed in claim 9, wherein the calculation unit is further configured to
conduct a wind-to-power conversion based on a weather forecast for the specific time period, and
determine the projected energy production of the wind turbine based upon the wind-to-power conversion.

15. The service planning tool as claimed in claim 14, wherein the calculation unit is further configured to calculate the projected revenue production based upon the specific time period and an energy price for generated power by the wind turbine for the specific time period.
